(19) United States
(12) Patent Application Publication
(10) Pub. No.: US 2005/0086163 A1
(43) Pub. Date: Apr. 21, 2005

(54) Electronic payment system

(76) Inventors: Daniel T. Johnson, Medina, MN (US); James W. Peterson, Lake Elmo, MN (US); Robert S. McConnell, Woodbury, MN (US); Daniel C. Riesland, Eagan, MN (US)

Correspondence Address: Sean D. Solberg, Esq.;DORSEY & WHITNEY LLP, Intellectual Property Department, 50 South Sixth Street, Suite 1500, Minneapolis, MN, 55402-1498, US

(21) Appl. No.: 10/922,364

(22) Filed: Aug. 20, 2004

Related U.S. Application Data
(60) Provisional application No. 60/496,432, filed on Aug. 20, 2003.

(51) Int. Cl. G06F 17/60

(52) U.S. Cl. 705/40

(57) ABSTRACT

A system and method for accomplishing electronic payment of work orders includes a server and a database having information relating to work order history. The server is programmed to track the work orders and can also generate an electronic payment request and send the request to an electronic payment center.

### CROSS-REFERENCE TO RELATED APPLICATIONS

This application claims priority to U.S. Provisional Application No. 60/496,432, filed on Aug. 20, 2003, which is hereby incorporated herein by reference in its entirety. This application also claims priority to co-pending U.S. patent application Ser. No. 09/883,779, entitled “Method and System for Managing Enterprise Assets,” filed on Jun. 18, 2001, which is hereby incorporated herein by reference in its entirety. It further claims priority to co-pending U.S. patent application Ser. No. 10/429,619, entitled “Refrigerant Loss Tracking and Repair,” filed on May 5, 2003, which is hereby incorporated herein by reference in its entirety.

### FIELD OF THE INVENTION

This invention relates generally to network-based electronic commerce. More specifically, it relates to a system and method for submitting electronic payment requests and receiving electronic payment confirmation.

### BACKGROUND OF THE INVENTION

Retailers, manufacturers, government entities, and other enterprises receive bills and invoices from suppliers or providers of goods and services. Processing and payment of these bills and invoices received for goods and services consumes substantial time and resources, and the costs continue to increase every year. Business enterprises typically write checks each month to pay these bills. In these bill payment cases, it is much more difficult to link the payment to the particular goods or services provided by the supplier, particularly in view of the sheer volume of checks issued each month.

In a typical paper-based bill processing system, a goods or services provider generates a bill for each account on a periodic basis. In addition to the bill, the provider associates the bill and any payment with the appropriate account. This is typically accomplished by including information such as an account number, an account balance, an amount due, and the payment due date. The provider then prints the bill, including this information, on a paper statement, encloses the statement in an envelope, and mails the envelope to the business enterprise. This phase of the process is often referred to as the “bill presentment” phase. Once the enterprise receives the bill from the provider, an agent of the enterprise typically attempts to confirm that the enterprise actually received the goods or services specified in the bill and that the amount is accurate. To pay the bill, the enterprise writes a check made out to the provider. The payment may partially or fully satisfy the amount due in the bill. The enterprise then mails the check to the provider. This phase of the process is often referred to as the “payment remittance” phase.

The overall cost of this process is very high. The process is expensive for both the provider, which must generate and send bills, and the enterprise, which must verify and issue payment of the bill. The process is also susceptible to significant human error. Accordingly, several electronic bill payment systems have been implemented to address these problems.

FIG. 1 shows an exemplary prior art electronic bill payment system 10. The system 10 allows a provider 12 and a business 14 to accomplish electronic payment using a provider bank 16, a consumer bank 18, a settlement bank 20, and a payment network 22. A method for presenting and paying bills using the system 10 includes several steps. The provider 12 sends a bill 24 by U.S. mail or email. To pay the bill 24, the business 14 transmits a transaction indicating an amount to pay to its bank 18. The bank 18 submits an electronic payment message to provider bank 16 via the payment network 22. Settlement is achieved using standard processes over the payment network 22, and the provider bank 16 sends a file to the provider 12 indicating payments received by the bank 16 on its behalf. The system 10, however, still requires the provider to generate and send a bill.

Accordingly, there is a need in the art for an automated system or method for electronically processing payments. There is a further need for a system or method minimizing or eliminating the need for human intervention in the payment process, so as to minimize associated costs and errors.

### BRIEF SUMMARY OF THE INVENTION

The present invention, in one embodiment, is a network-based electronic payment of system including a first database including a work order history relating to a piece of equipment located at a site and a server including software for communicating with an electronic payment center over a network. The server receives authorization to issue an electronic payment request from a user on a client computer, and the server generates the electronic payment request and transmits the request to the electronic payment center.

In another embodiment, the present invention is a method of submitting electronic payment requests. The method includes maintaining at a first database a work order history relating to a piece of equipment located at a site, tracking progress made on a work order by a service provider, and generating an electronic payment request, in response to a payment authorization.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is schematic diagram showing an electronic bill payment system known in the prior art.

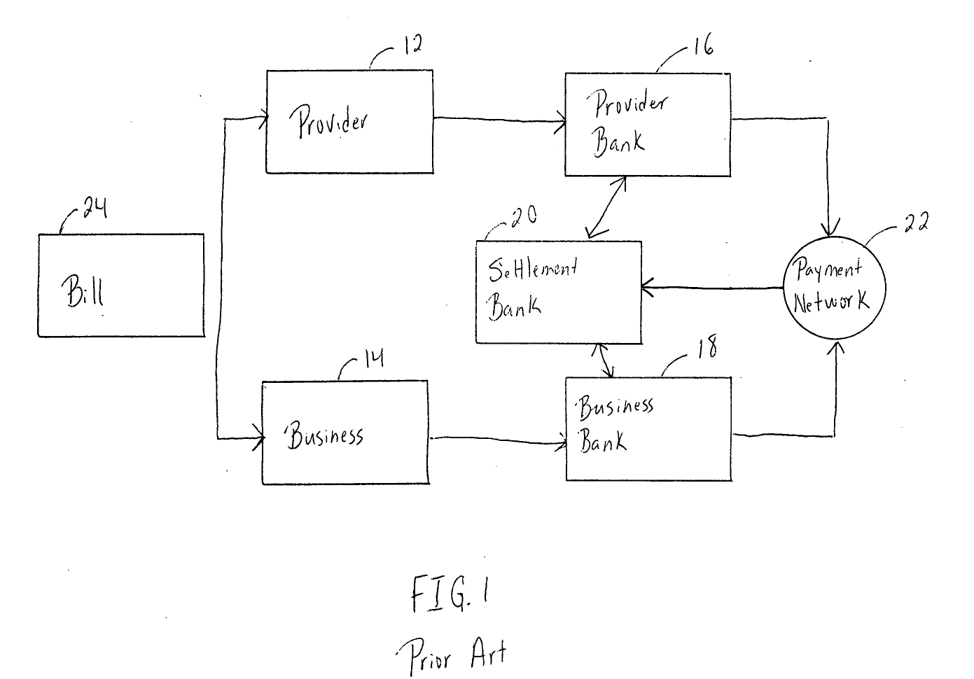

FIG. 2 is a flow chart illustrating an electronic payment method, according to one embodiment of the present invention.

FIG. 3 is a flow chart illustrating an electronic payment method, according to another embodiment of the present invention.

FIG. 4 is a block diagram illustrating an electronic payment system, according to one embodiment of the present invention.

### DETAILED DESCRIPTION

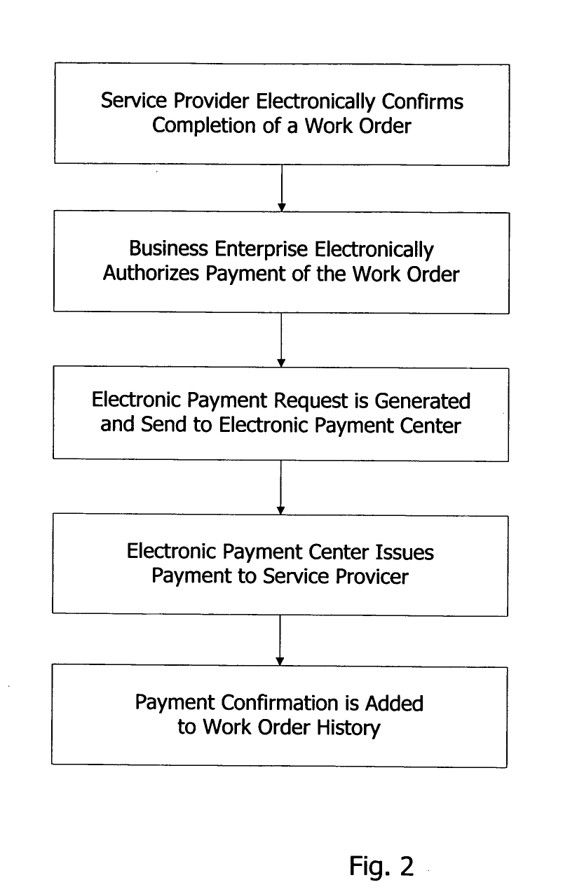

FIG. 2 is a flow chart showing an electronic payment method 30 according to one embodiment of the present invention. As shown in FIG. 2, the method 30 includes a service provider electronically confirming completion of repair or maintenance activity pursuant to a work order issued by a client or business enterprise (block 32). The business enterprise then electronically authorizes payment for completion of the work order (block 34). An electronic payment request is then generated and transmitted to an electronic payment center (block 36). The electronic payment center issues payment to the service provider and provides confirmation of the payment (block 38). Finally, the payment confirmation is added to the history of the corresponding work order (block 40).

In one embodiment, the present invention is used in combination with a system such as that disclosed in co-pending U.S. patent application Ser. No. 09/883,779. This system includes a central server and database for tracking information relating to various assets of an enterprise. The server and database is further configured to generate a work order history relating to each individual asset. The system includes a client computer which allows an employee of the enterprise to access the central server and database to view asset and work order history information. Similarly, the system may allow service providers to access the central server and database to view and enter information relating to work orders for which the service provider has been named to perform the work. The system allows the service provider to enter information relating to work performed on an asset and to confirm completion of activities specified in the work order. According to the present invention, the server is configured to allow the employee of the enterprise to authorize electronic payment of a completed work order.

Once an employee of the enterprise authorizes electronic payment of a completed work order, the server generates an electronic payment request for transmission to an electronic payment center. The electronic payment request may take any known form, including an e-mail message or an electronic data file. In one embodiment, the electronic payment center is the Power Track® service offered by U.S. Bank. In this embodiment, the electronic payment request is generated in the specific format required by Power Track® (see Appendix A). For example, in this embodiment, the electronic file will be an XML file containing various fields of information, including one or more of the work order number, the amount of the authorized payment, a breakdown of the work completed, a time and date of the request, the name of the business enterprise, the business enterprise account number, the name of the service provider, and the service provider account number. In other embodiments, any known electronic payment centers can be used. In one embodiment, the electronic request is generated in the EDI 850 transaction format.

Upon receiving a valid request, the electronic payment center processes the request and issues an electronic payment to the service provider. The electronic payment center may, immediately upon receiving an electronic payment request, generate an electronic confirmation of the request and send that confirmation to the server making the request. In one embodiment, this action is a direct transfer of funds from an account of the business enterprise to an account of the service provider. In another embodiment, this action is simply a payment by the electronic payment center to the service provider, and the business enterprise is later billed on a periodic basis for all payments made on its behalf. The service provider, in one embodiment, must be registered with the electronic payment center to allow the center to accomplish the funds transfer. In one embodiment, the electronic confirmation is sent in the EDI 811 format.

Upon successful completion of electronic payment to the service provider, confirmation of the payment is provided to the server. The server then updates its database with the confirmation information. For example, the server will update the work order history to indicate that the service provider has received payment for its services.

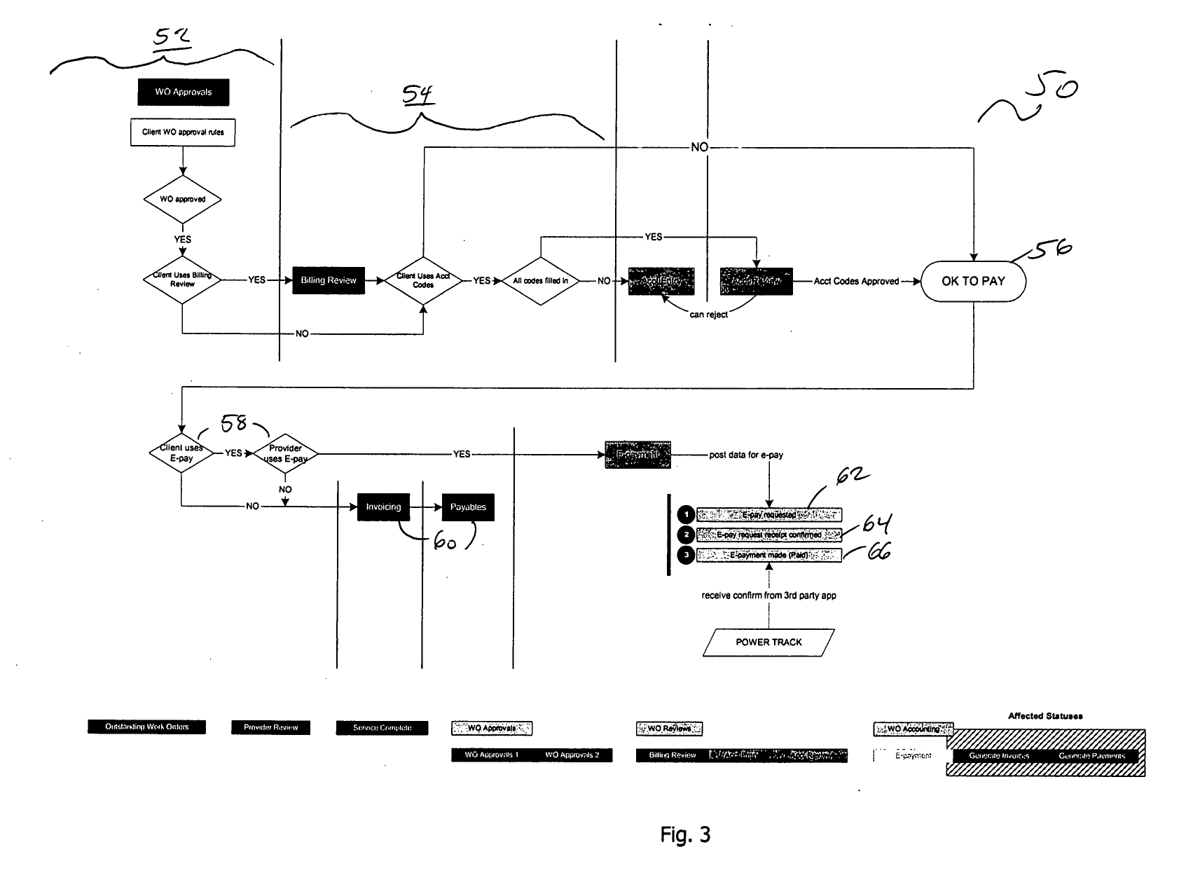

FIG. 3 is a flow chart showing an electronic payment method 50 according to another embodiment of the present invention. The method 50 includes approval of the completed work order (block 52) and a review of an electronic bill (block 54). Electronic payment of the work order is then authorized (block 56). The system then determines if both the client (i.e., business enterprise) and the service provider are configured for electronic work order payment (block 58). If not, the electronic payment system of the present invention is not used, and instead the payment is processed using a paper-based system. If the enterprise and service provider are configured for electronic payment, an electronic payment request is made (block 62). Confirmation of the payment request is sent by the electronic payment center (block 64) and confirmation of the electronic payment is provided by the electronic payment center, at which point the transfer is complete (block 66). In one embodiment, the electronic payment center is U.S. Bank's Power Track® service.

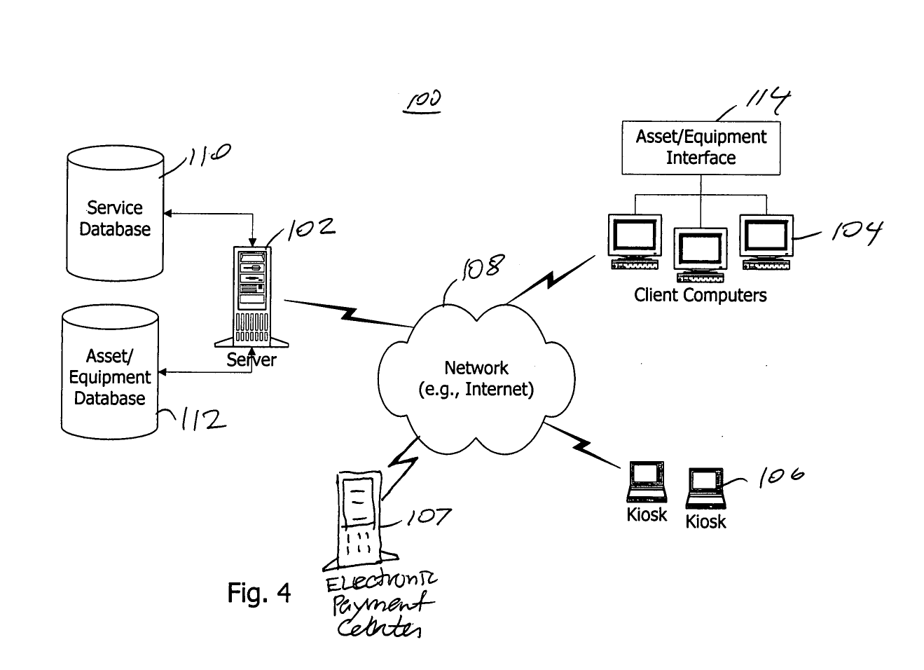

FIG. 4 is a schematic diagram showing a network-based electronic payment system 100 according to a further embodiment of the present invention. As shown in FIG. 4 the system 100 includes a server 102 in communication with client computers 104, kiosks 106, and an electronic payment center 107 through a network 108. As further shown, in one embodiment, the server 102 is in communication with a service database 110 and an asset or equipment database 112. In one embodiment, the service database 110 and the equipment database 112 are combined into a single database. The client computers 104 are in communication with individual pieces of equipment through an asset/equipment interface 114. In the system 100, according to one embodiment, the client computers 104 receive information from refrigeration equipment, which is part of an overall refrigeration system, through the interface 114. This information can be stored in the equipment database 112. Work order history information can be stored in the service database 110. The information is entered by the service providers or the business enterprise using the client computers 104 or the kiosks 106. In one embodiment, the kiosks 106 are located at the site where the assets or equipment are located to allow for convenient data entry by the service providers.

During operation of the system 100, the server 102 tracks maintenance and repair information by compiling work order history information. The business enterprise can then access the work order history for a particular asset using the client computers 104. An agent or employee of the business enterprise can electronically authorize payment of a particular work order. Upon such authorization, the server 102 to creates an electronic payment request for transmission to the electronic payment center 107. The electronic payment center 107 acknowledges receipt of the electric payment request, and then transmits funds to the service provider specified in the requests. This transmission may occur in real-time or near real-time, or it may occur at a prescheduled time. The electronic payment center 107 then confirms the payment to the service provider by sending an electronic message to the server 102. In one embodiment, the server 102 then updates the asset equipment database 112 to reflect the confirmation of payment of the work order.

The present invention is not limited to electronic payment to a service provider. According to an alternative embodiment, any electronic payment system and method of the present invention provides for electronic payment to any entity to which payment is to be made. That is, the system and method of the present invention can be used to make an electronic payment to any provider of any goods or services, including asset suppliers, parts suppliers, consumable suppliers, providers of transportation or moving services, or any other kind of provider to which money is owed by the enterprise (which can be referred to generally as a “provider entity”). In this embodiment, the entity providing the product(s) or service(s) electronically confirms that the product or service has been provided as described above for a service provider, and the system and method of the present invention proceeds to complete electronic payment to the provider entity as set forth herein.

Although the present invention has been described with reference to preferred embodiments, persons skilled in the art will recognize that changes may be made in form and detail without departing from the spirit and scope of the invention.

1. A network-based electronic payment of system comprising:
a first database comprising a work order history relating to a piece of equipment located at a site; and
a server comprising software for communicating with an electronic payment center over a network,
wherein the server is configured to receive authorization to issue an electronic payment request from a user on a client computer, and
wherein the server is configured to generate the electronic payment request and transmit the request to the electronic payment center.

2. The system of claim 1 further comprising a second database including a plurality of service provider characteristics.

3. The system of claim 1 further comprising a kiosk located at the site, wherein the kiosk is programmed to allow a service provider to enter information relating to a work order.

4. The system of claim 1 wherein the server is further configured to receive a confirmation of payment from the electronic payment center after the service provider receives payment

5. The system of claim 4 wherein the server is configured to, upon receipt of the confirmation, update the work order history to reflect the payment to the service provider.

6. The system of claim 1 wherein the electronic payment request includes a work order number and a payment amount.

7. The system of claim 6 wherein the electronic payment request further includes at least one of the group consisting of: a summary of the work completed, a time and date of the request, the name of the user, the user account number, the name of the service provider, and the service provider account number.

8. The system of claim 1 wherein the electronic payment request is in XML format.

9. A method of submitting electronic payment requests, the method comprising:
maintaining at a first database a work order history relating to a piece of equipment located at a site;
tracking progress made on a work order by a service provider; and
generating an electronic payment request in response to a payment authorization.

10. The method of claim 9 further comprising maintaining at a second database a plurality of service provider characteristics.

11. The method of claim 9 further comprising transmitting the electronic payment request to an electronic payment center.

12. The method of claim 9 further comprising receiving a payment confirmation from the electronic payment center.

13. The method of claim 12 further comprising updating the work order history to reflect the payment confirmation.

14. The method of claim 9 wherein the electronic payment request is in an XML format.

15. The method of claim 9 wherein the electronic payment request includes a work order number and a payment amount.

16. The method of claim 15 wherein the electronic payment request further includes at least one of the group consisting of: a summary of the work completed, a time and date of the requests, the name of the user, the user account number, the name of the service provider, and the service provider account number.

17. A network-based electronic payment of system comprising:
a first database comprising an invoice history relating to a site; and
a server comprising software for communicating with an electronic payment center over a network,
wherein the server is configured to receive authorization to issue an electronic payment request from a user on a client computer, and
wherein the server is configured to generate the electronic payment request and transmit the request to the electronic payment center.

18. The system of claim 17 further comprising a second database including a plurality of provider entity characteristics.

19. The system of claim 17 further comprising a kiosk, wherein the kiosk is programmed to allow a provider entity to enter invoice information.

20. The system of claim 17 wherein the server is further configured to receive a confirmation of payment from the electronic payment center after the provider entity receives payment

21. The system of claim 20 wherein the server is configured to, upon receipt of the confirmation, update the invoice history to reflect the payment to the provider entity.

22. The system of claim 17 wherein the electronic payment request includes an invoice number and a payment amount.

23. The system of claim 22 wherein the electronic payment request further includes at least one of the group consisting of: a summary of the service or product provided, a time and date of the request, the name of the user, the user account number, the name of the provider entity, and the provider entity account number.

24. The system of claim 17 wherein the electronic payment request is in XML format.
